(19) United States
(12) Patent Application Publication
(10) Pub. No.: US 2005/0125524 A1
(43) Pub. Date: Jun. 9, 2005

(54) Cache system in factory server for software dissemination

(76) Inventors: Babu K. Chandrasekhar, Austin, TX (US); Shaofei Chen, Austin, TX (US); Timothy W. Cox, Austin, TX (US); Steven A. Grigsby, Round Rock, TX (US)

Correspondence Address: HAMILTON & TERRILE, LLP, P.O. BOX 203518, AUSTIN, TX, 78720, US

(21) Appl. No.: 10/730,435

(22) Filed: Dec. 8, 2003

(51) Int. Cl. G06F 15/173; G06F 9/46

(52) U.S. Cl. 709/223; 719/320

(57) ABSTRACT

A method and apparatus for minimizing the size of the cache that is required to store software packages for installation on an information handling system. An analysis is conducted on the individual program files contained in a software application file. In the analysis, the software application file is disassembled into the individual program files and each of the program files is decompressed and stored in temporary file directories. Files that are common to each of the software packages are identified. After the file comparison, the method and apparatus of the present invention is used to re-group the files to generate a composite program file library that contains all of the program files needed to regenerate the software application files. This composite program file library is then stored on a cache in a factory server used to manufacture information handling systems in a build to order process.

### BACKGROUND OF THE INVENTION

1. Field of the Invention

The present invention relates in general to the field of information handling systems and, more particularly, to an improved method and apparatus for storing and disseminating software using a cache memory on a factory server used in the manufacturing of information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In recent years, there has been an increase in the number of information handling systems that are manufactured based on a “build to order” process that allows a customer to specify specific hardware and software options. In “build to order” manufacturing systems, the operating system and other software files are stored as groups of compressed (“ZIP”) files that are organized according to software part numbers (sometimes referred to herein as “SRVs”). Each of the software part numbers is assigned a shell script (top script), and each of these scripts contains the names of corresponding ZIP files to download. A typical operating system file is approximately 500-650 megabytes, while a base image size is approximately 1-2 gigabytes. Different operating systems, multiple language versions and their related service packs can add up to several gigabytes of memory. These large file sizes cause problems with regard to the size of the cache required in a factory server used for manufacturing. In addition, the larger files require more download time, which in turn, results in longer “burn” time for each system in the manufacturing process.

In view of the foregoing, there is a need for a method and apparatus to minimize the size of files that must be stored in the cache of a server used in a “build to order” process for manufacturing information handling systems. Such a system is provided by the present invention, as described hereinbelow.

### SUMMARY OF THE INVENTION

The present invention overcomes the shortcomings of the prior art by providing a method and apparatus for minimizing the size of the cache that is required to store software packages on a factory server for installation on an information handling system manufactured using a built-to-order system. In an embodiment of the invention, a plurality of software applications are received and are disassembled to separate the individual constituent program files. These program files are decompressed and are stored in temporary file directories. Program files that are common to each of the software applications are identified and indexed. After the file analysis, the files are regrouped and a stored as a new set of compressed (ZIP) files. Once the new set of ZIP files has been created, the top level scripts for the software application images are updated for use with the new ZIP files to allow the desired combinations of software applications to be regenerated. The new ZIP files are then loaded into the factory servers for use in manufacturing information handling systems.

The method and apparatus of the present invention overcomes the shortcomings of the prior art by minimizing the amount of cache memory needed for the factory server used in the build to order system. In addition, the present invention significantly reduces the amount of “burn” time needed in the manufacturing of information handling systems, thereby resulting in increased throughput for the factory.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of an automated build-to-order system for installing software on an information handling system.

FIG. 2 is a system block diagram of an information handling system.

FIG. 3 is an illustration of a software application comprising a plurality of program files.

FIG. 4 is an illustration of a plurality of decompressed program files after disassembly of the software applications illustrated in FIG. 3.

FIG. 5A is an illustration of a software image file comprising a plurality of reassembled program files.

FIG. 5B is an illustration of a software image file comprising the original software applications containing a plurality of redundant program files.

FIG. 6 is an illustration of an embodiment of an automated system for analyzing a plurality of software systems and for generating a plurality of base images that requires minimal storage space in the cache of a factory server.

FIG. 7 is a flowchart illustration of the processing steps for implementing the method of the present invention for reducing the amount of cache storage needed in a factory server.

### DETAILED DESCRIPTION

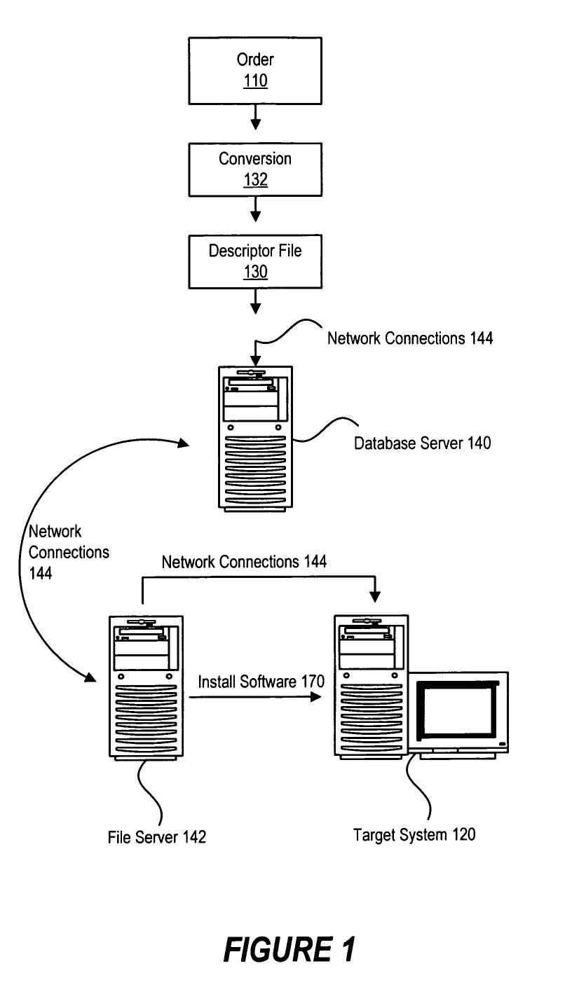

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor and software. The software may include a particular version of an operating system along with all appropriate driver software and other application software along with appropriate software bug fixes. Before target information handling system 120 is shipped to the customer, the plurality of components are installed and tested. Such software installation and testing advantageously ensures a reliable, working information handling system which is ready to operate when received by a customer.

Because different families of information handling systems and different individual computer components require different software installation, it is necessary to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling system 120 which components are defined by the order 110. In an embodiment of the present invention, the component descriptors are included in a descriptor file called a system descriptor record which is a computer readable file containing a listing of the components, both hardware and software, to be installed onto target information handling system 120. Having read the plurality of component descriptors, database server 140 provides a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 120. The software installation is controlled by a software installation management server, discussed in greater detail below, that is operable to control the installation of the operating system and other software packages specified by a customer.

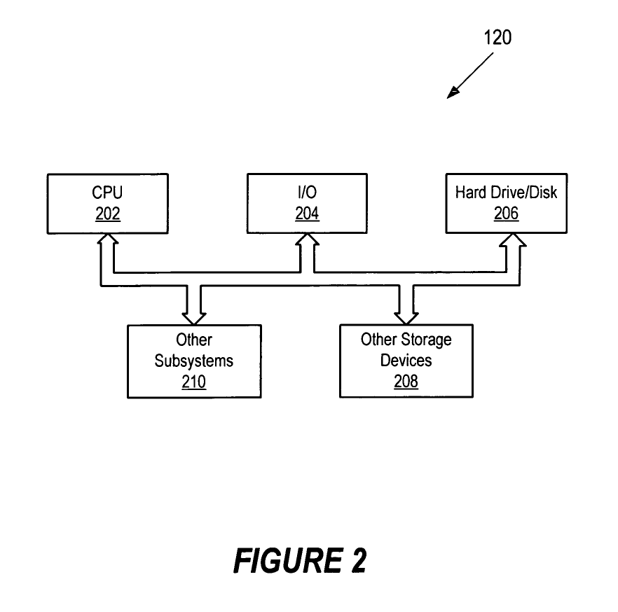

FIG. 2 is a generalized illustration of an information handling system, such as the target information handling system 120 illustrated in FIG. 1. The information handling system includes a processor 202, input/output (I/O) devices 204, such as a display, a keyboard, a mouse, and associated controllers, a hard disk drive 206, and other storage devices 208, such as a floppy disk and drive and other memory devices, and various other subsystems 210, all interconnected via one or more buses 212. The software that is installed according to the versioning methodology is installed onto hard disk drive 206. Alternately, the software may be installed onto any appropriate non-volatile memory. The non-volatile memory may also store the information relating to which factory build environment was used to install the software. Accessing this information enables a user to have additional systems corresponding to a particular factory build environment to be built.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

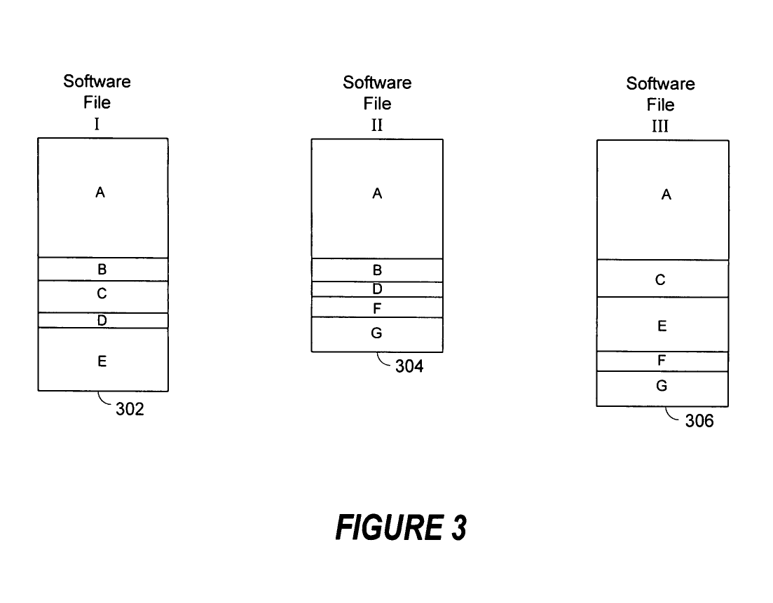

FIG. 3 is a conceptual illustration of a plurality of software application images 302, 304 and 306, each of which comprises a plurality of program files. For purposes of discussion herein, a software operating system or other high level software file, such as a word processor, will be referred to as a “software application,” while the plurality of files that are contained within the software application will be referred to as the “program files.” Each of the software application images illustrated in FIG. 3 comprise a plurality of program files illustrated by the reference letters A, B, . . . , G. Each of the software applications 302, 304, and 306 are comprised of various combinations of some, but not all, of the program files A, B, . . . , G. As will be understood by those of skill in the art, a library of program files A, B, . . . , G contains all of the files that are necessary to reconstruct the software applications 302, 304, and 306.

Typically, the software applications 302, 304, and 306 are supplied by vendors in a compressed format, such as a “ZIP” file, wherein the various program files are compressed. In the method and apparatus of the present invention, the software applications, 302, 304, and 306 are initially disassembled and each of the program files are decompressed or “un-ZIPped.”

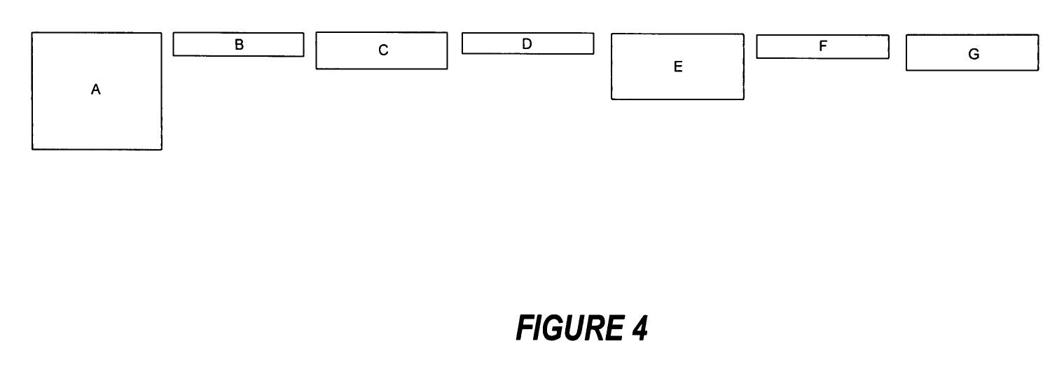

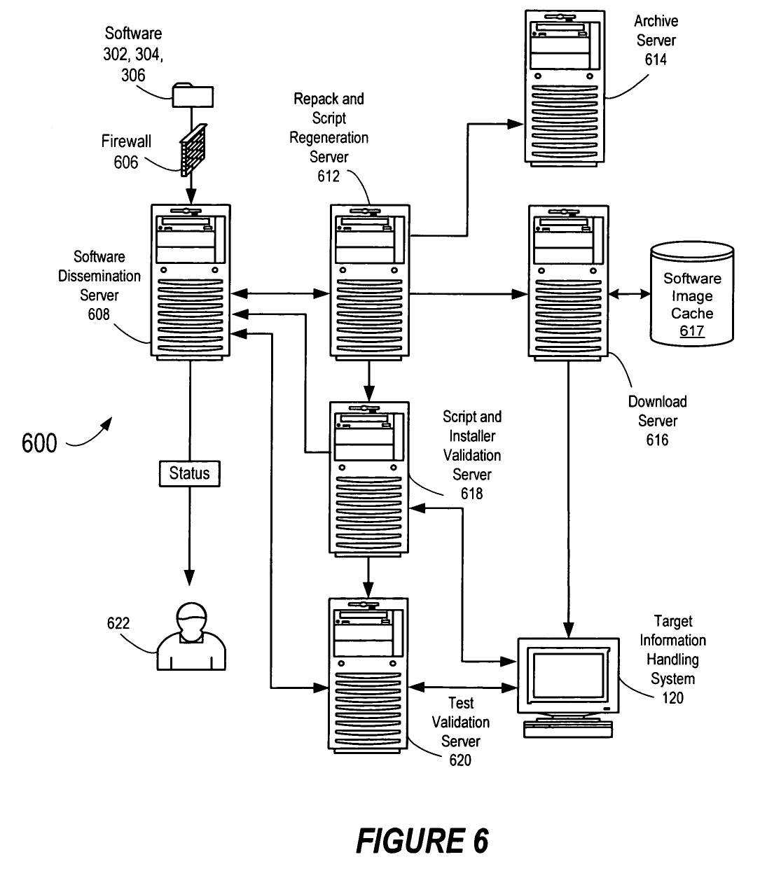

FIG. 4 is a conceptual illustration of the disassembled and decompressed program files A, B, . . . , G wherein each of the program files represents an independent program file that can be used to reassemble a software application. These individual program files are stored in temporary directories and are then indexed and analyzed in a software dissemination server, discussed hereinbelow in FIG. 6, to generate an index of program files representing all of the program files that are needed to generate a family of software applications, such as the software applications 302, 306 and 308 illustrated in FIG. 3.

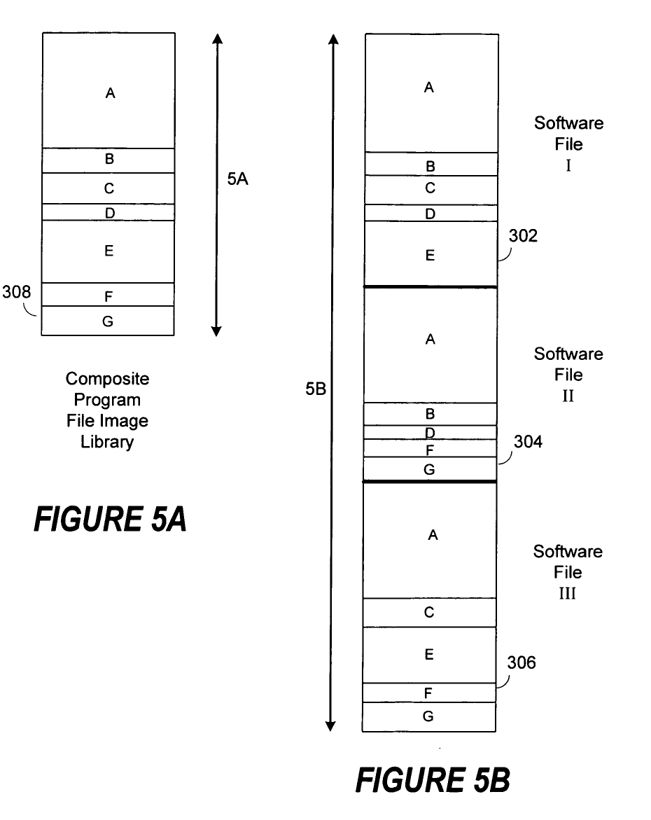

FIG. 5A illustrates a composite program file image library 308 that contains all of the program files A, B, . . . , G that are necessary to create the original software applications, 302, 304, and 308. The composite program file image library contains one copy of each of the unique program files; however, all redundant copies of the program files have been removed. The program file image library 308 can be stored in a program storage cache in a factory server, as discussed hereinbelow, to allow improved efficiency in the manufacture of information handling systems.

FIG. 5B is a comparative illustration of the relative size of the combined software applications 302, 304, and 306 that would be stored in a program storage cache in a factory server. As can be seen, the amount of storage (illustrated by 5A) required to store each of the software applications 302, 304, and 306 is substantially larger than the amount of storage (illustrated by 5B) that is required to store the composite program file image library 308 that contains the individual program files A, B, . . . , G.

FIG. 6 is an illustration of the components of the automated system for converting, optimizing and disseminating software in accordance with the present invention. Software applications 302, 304 and 306 are delivered to the system via a firewall 606 and are received by a software dissemination server 608. When a new software application is received, the software dissemination server 608 unpacks the application file into individual program files. The software dissemination server 608 scans the software applications for viruses and then transfers the packages to the repack and script regeneration server 612. The repack and script regeneration server 612 is operable to disassemble the software applications 302, 304, and 306 into individual program files. In this process, the server 612 disassembles and decompresses the software applications 302, 304, and 306 into the individual program files, such as the program files A, B, . . . , and G discussed hereinabove in connection with FIGS. 3-6 and stores these individual program files in temporary directories.

The repack and script regeneration server 612 compares the individual program files with the existing files in the composite program library indexed and stored in the archive server 614. If an individual program file already exists in the composite program file library, that file is discarded to reduce the redundancy. The repack and script regeneration server 612 establishes a reference in the shell script for that software application to the file in the composite program file library. That file is already available on the download server 616 as well.

The repack and script regeneration server 612 also constructs an index of the program files contained in each of the software applications 302, 304, 306. This index and the related program files are used to construct a composite program file image library that is transferred to the download server 616, which includes a software image cache 617. The composite program file image library contains one copy of each of the unique program files but, as discussed herein, all of the redundant copies of the program files have been removed. The program files, e.g., program files A, B, . . . , G, assembled into the composite program file library 308, as discussed hereinabove, are stored in the software image cache 617 to decrease the time required to access these files, thereby improving the performance of the “build to order” system.

The repack and script regeneration server 612 generates top level factory scripts for each of the program files to produce “factory installable bits” corresponding to the various software applications. These “factory installable bits” are then transferred to the download server 616. Copies of the program file images are also transferred to an archive server 614. The repack and script regeneration server 612 then generates a signal authorizing the script and installation validation server 618 to generate appropriate commands to control downloading of software application to the target information handling system 120. The results of the installation are monitored by the server 618 and results are communicated to the software dissemination server 608 while the actual software images are downloaded by the download server 616 onto the hard drive or other storage media of the target information handling system 120.

After the software images have been downloaded to the target information handling system 120, tests are performed by a test validation sever 620 which performs a series of tests to confirm that the software images have been properly installed and that the operational integrity of the software package is satisfactory. The results of the test performed by the test validation server 620 are communicated to the software dissemination server 608 which is operable to generate a status report for viewing by a program manager 622.

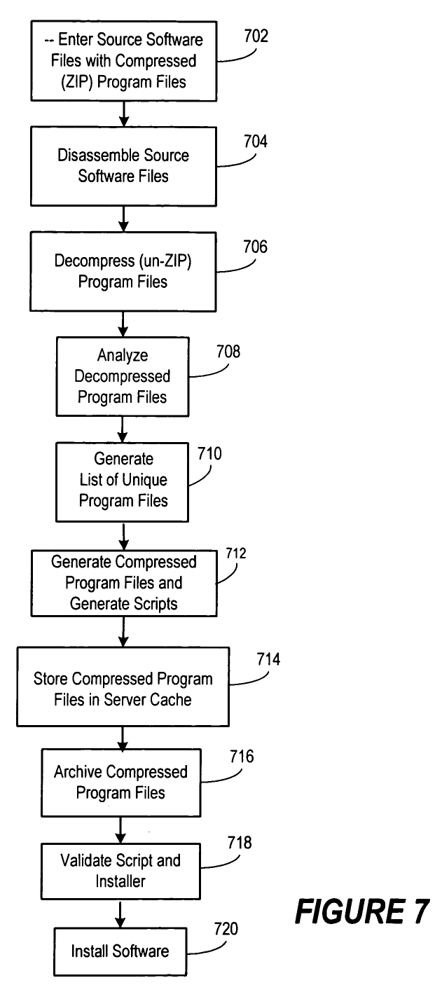

FIG. 7 is a flowchart illustration of the processing steps implemented by the system of the present invention. In step 702, the source software applications containing the compressed program files are entered into the system. In step 704, the source software applications are disassembled to obtain the individual program files. In step 706, the program files are decompressed (un-ZIPped) and stored in temporary directories. In step 708, the decompressed program files are analyzed and in step 710 an index of the unique program files is created and redundant copies of the program files are eliminated. In step 712 the repack and regeneration script server 612 generates compressed program files and top level scripts which, in step 714, are stored on the download server 616. In step 716, the compressed archive files are stored on the archive server 614. In step 718, the factory script is validated and installation of the software files is authorized. In step 720, software images are downloaded to the target information handling system.

Testing of the software can be accomplished using the system and methods described in co-pending application Ser. No. 10/267,513, filed on Oct. 9, 2002, entitled “Method and System for Test Management,” which by this reference is incorporated for all purposes.

### Other Embodiments

Other embodiments are within the following claims.

For example, the above-discussed embodiments include software modules that perform certain tasks. The software modules discussed may include script, batch, or other executable files. The software modules may be stored on a machine-readable or computer-readable storage medium such as a disk drive. Storage devices used for storing software modules may be magnetic floppy disks, hard disks, or optical discs such as CD-ROMs or CD-Rs, for example. A storage device used for storing firmware or hardware modules may also include a semiconductor-based memory, which may be permanently, removably or remotely coupled to a microprocessor memory system. Thus, the modules may be stored within a computer system memory to configure the computer system to perform the functions of the module. Other new and various types of computer-readable storage media may be used to store the modules discussed herein. Consequently, the invention is intended to be limited only by the spirit and scope of the appended claims, giving full cognizance to equivalents in all respects.

Although the present invention has been described in detail, it should be understood that various changes, substitutions and alterations can be made hereto without departing from the spirit and scope of the invention as defined by the appended claims.

1. A system for automated dissemination of software to an information handling system, comprising:
a distribution server operable to receive a software application file;
a repack and script regeneration server operably connected to said distribution server, said repack and script server operable to:
disassemble said software application file into a plurality of individual program files;
generate an index of said individual program files;
identify and remove redundant program files;
generate a composite program file library containing a plurality of said program files; and
generate scripts for automatically controlling the transfer of said program files to an information handling system; and
a download server operable to transfer said software to a target information handling system.

2. The system of claim 1, further comprising a script validation server operably coupled to said repack and script regeneration server and said distribution server, said script validation server operable to generate commands to automatically control the downloading of said program files to a target information handling system.

3. The system of claim 1, wherein said download server comprises a software image cache, said composite program file library being stored in said software image cache.

4. The system of claim 1, wherein said distribution server is operable to scan said software file for viruses.

5. The system of claim 1, further comprising a test control server operable to confirm the download of said software file to said target information handling system and to verify proper operation of said software file on said target information handling system.

6. The system of claim 1 wherein said distribution server is operable to notify a manager regarding the status of the software file within the software distribution system.

7. The system of claim 1 further comprising an archive server, wherein said repack and script regeneration server is operable to transfer copies of composite program file library to said archive server for storage thereon.

8. A method for automated dissemination of software to an information handling system, comprising:
receiving a software application file;
disassembling said software application file into a plurality of individual program files;
generating an index of said individual program files;
identifying and removing redundant program files;
generating a composite program file library containing a plurality of said program files; and
transferring said software to a target information handling system.

9. The method of claim 8, further comprising the step of generating commands to automatically control the downloading of said program files to a target information handling system.

10. The method of claim 9, further comprising the step of storing said composite program file library in a software image cache.

11. The method of claim 8, further comprising the step of scanning said software file for viruses.

12. The method of claim 8, further comprising the steps of confirming the download of said software file to said target information handling system and verifying proper operation of said software file on said target information handling system.

13. The method of claim 8, further comprising the step of notifying a manager regarding the status of the software file within the software distribution system.

14. The method of claim 8, further comprising the step of transferring copies of said composite program file library to an archive server for storage thereon.

15. An information handling system, comprising:
a data processor;
data storage having a software file stored thereon, said software file being transferred to said data storage by an automated software dissemination system comprising:
a distribution server operable to receive a software application file;
a repack and script regeneration server operably connected to said distribution server, said repack and script server operable to:
disassemble said software application file into a plurality of individual program files;
generate an index of said individual program files;
identify and remove redundant program files;
generate a composite program file library containing a plurality of said program files;
generate scripts for automatically controlling the transfer of said program files to an information handling system; and
a download server operable to transfer said software to a target information handling system.

16. The information handling system of claim 15, further comprising a script validation server operably coupled to said repack and script regeneration server and said distribution server, said script validation server operable to generate commands to automatically control the downloading of said program files to a target information handling system.

17. The information handling system of claim 16, wherein said download server comprises a software image cache, said composite program file library being stored in said software image cache.

18. The information handling system of claim 15, wherein said distribution server is operable to scan said software file for viruses.

19. The information handling system of claim 15, further comprising a test control server operable to confirm the download of said software file to said information handling system and to verify proper operation of said software file on said target information handling system.

20. The information handling system of claim 15 wherein said distribution server is operable to notify a manager regarding the status of the software file within the software distribution system.
